(19) United States
(12) Patent Application Publication
(10) Pub. No.: US 2024/0176766 A1
(43) Pub. Date: May 30, 2024

(54) DYNAMIC MODELING USING PROFILES

(71) Applicant: SAP SE, Walldorf (DE)

(72) Inventors: Naved Ahmed, Bangalore (IN); Saritha Palli, Bangalore (IN); Shweta Gupta, Bangalore (IN)

(21) Appl. No.: 18/071,898

(22) Filed: Nov. 30, 2022

(51) Int. Cl. G06F 16/21; G06F 16/25

(52) U.S. Cl. CPC G06F 16/212; G06F 16/25

(57) ABSTRACT

Mechanisms are disclosed for enabling transformation and extension of data models in connection with a dynamic, automated data processing mechanism. A design-time profile comprising a collection of transformations of a static data model into one or more dynamic data models is received. During runtime of a software application, the one or more dynamic data models is rendered to create a data model variant. Multiple profiles for the one or more dynamic data models are created with varying levels of data model detail. A plurality of transformations of the design-time profile are created at different time stamps. One or more exported profiles associated with the plurality of transformations of the design-time profile are exported by way of one or more machine readable templates.

### TECHNICAL FIELD

Embodiments generally relate to providing extensible data models, and more particularly to enabling transformation and extension of data models in connection with a dynamic, automated data processing mechanism.

Many software applications involve scenarios in which data modeling is needed to represent various application usages. For example, certain online platforms provide data models for photos, videos, comments, statuses, profiles etc. Such platforms may also provide data models for E-mails, attachments, profiles, contacts etc. Other types of software applications also employ data models, such as Business Objects (BO), Information Lifecycle Management (ILM) Objects, Archiving Objects (AO) and Information Retrieval Framework (IRF) models. Traditionally data models may be large and static for completeness and (in some cases) compliance, for example, software applications delivering IRF models may contain significant amounts of information (fields) that may be relevant to in certain use cases and not in others, such as technical info, and fields not in scope of the current purpose. Where a static data model contains such superfluous information, users of the data model would need to create multiple versions and/or extensions for the same delivered model based on their business purposes, localization needs, legal entity etc. In some cases, such custom transformations of static data models would require cumbersome manual development, including writing new software code. Known modeling approaches fail to provide low-code or no code mechanisms for creating dynamic versions for static models.

Accordingly, what is needed is a mechanism for enabling transformation of data models in a dynamic extensible manner that overcomes the above-described problems and challenges in a low code or no code way.

### SUMMARY

Disclosed embodiments address the above-mentioned problems by providing one or more non-transitory computer-readable media storing computer-executable instructions that, when executed by a processor, perform a method for enabling transformation and extension of data models in connection with a dynamic, automated data processing mechanism, the method comprising: receiving a design-time profile comprising a collection of transformations of a static data model into one or more dynamic data models, rendering, during runtime of a software application, the one or more dynamic data models to create a data model variant, wherein multiple profiles for the one or more dynamic data models are created with varying levels of data model detail, and wherein a plurality of transformations of the design-time profile are created at different time stamps, and exporting, by way of one or more machine readable templates, one or more exported profiles associated with the plurality of transformations of the design-time profile.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present teachings will be apparent from the following detailed description of the embodiments and the accompanying drawing figures.

### BRIEF DESCRIPTION OF THE DRAWING FIGURES

Embodiments are described in detail below with reference to the attached drawing figures, wherein:

FIG. 1 is a system diagram illustrating extensible data models consistent with the present teachings.

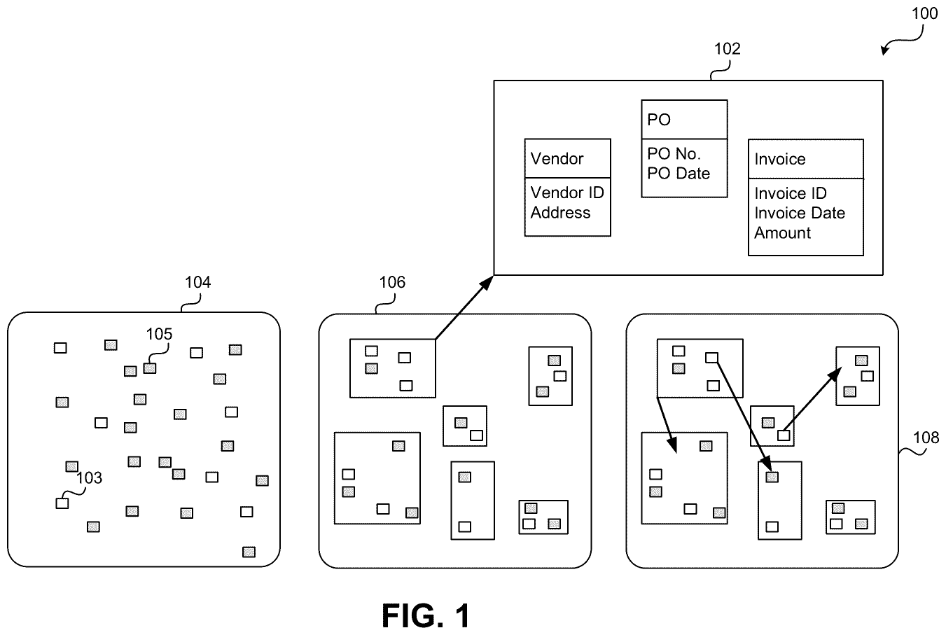

FIG. 2 is a diagram illustrating example transformations of data models in a dynamic extensible manner.

FIG. 3 shows an example method of providing a transformation of data models in a dynamic extensible manner.

FIG. 4 is a flow diagram illustrating another example method for providing a transformation of data models in a dynamic extensible manner according to certain embodiments.

FIG. 5 is a diagram illustrating a sample computing device architecture for implementing various aspects described herein.

The drawing figures do not limit the present teachings to the specific embodiments disclosed and described herein. The drawings are not necessarily to scale, emphasis instead being placed upon clearly illustrating the principles of the disclosure.

### DETAILED DESCRIPTION

The subject matter of the present disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the present claims. Terms should not be interpreted as implying any particular ordering of various steps described unless the order of individual steps is explicitly described.

The following detailed description of embodiments references the accompanying drawings that illustrate specific embodiments in which the present teachings can be practiced. The described embodiments are intended to illustrate aspects of the present teachings in sufficient detail to enable those skilled in the art to practice the present teachings. Other embodiments can be utilized, and changes can be made without departing from the claims. The following detailed description is, therefore, not to be taken in a limiting sense. The scope of embodiments is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

### Overview

The present teachings describe methods and systems to enable transformation and extension of data models in connection with a dynamic, automated data processing mechanism. Mechanisms consistent with the present teachings may be implemented in connection with one or more information retrieval frameworks (IRF). However, it is understood that the present teachings may be implemented in any other data modeling scenario. Mechanisms consistent with the present teachings may create one or more design time profiles which may comprise one or more collections of transformations (attributes & behaviors) for a static data model. A Profile renders the model to create a variant at runtime. Multiple profiles for the same model may be created with varying weights (levels of detail). The static data model may be dynamically rendered with many profiles creating different variants of the same model. Multiple transformations for the same profile can be created at different timestamps. A timeline may be created by a series of transformations. This enables creation and/or re-creation of the model variant based on a time-slice (by moving up or down a timeline). A higher-order profile can also be maintained which encompasses multiple models based on end-to-end purposes. Higher-order-profiles facilitate the definition of settings across data sets, such as for example, database tables, which may be common across data models. Use of higher-order profiles further improves the reusability of profiles. In some embodiments, Provisions may be made to export one or more profiles in a machine-readable template. Templates are reusable and may be published for consumption by various users and in connection with various systems. Provision may also be made for consumption of templates in target system via template imports.

The components represent data entities (tables or any other data storage objects) and the arrows represent the relationships between these entities implying how they are functionally and technically linked to each other. For example, there are 3 entities representing vendor, purchase order header and purchase order items. A vendor can be related to many purchase orders. A purchase order header can contain many purchase order items.

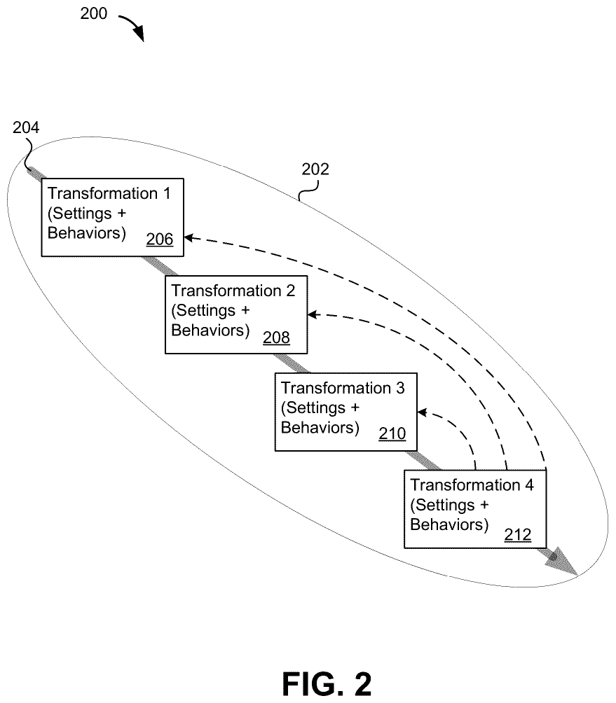

FIG. 2 is a diagram 200 illustrating example transformations of data models in a dynamic extensible manner. As shown in connection with diagram 200, profile 202 is a collection of transformations, which transformations themselves are made up of settings and behaviors for a static data model. Consistent with the present teachings, multiple transformations for the dame profile can be created at different timestamps across a timeline such as timeline 204. Transformation 206 designated “Transformation 1,” may be a first transformation that is created at a first timestamp. Further along timeline 204, at a second timestamp, transformation 208 may be created. At third and fourth timestamps, transformation 210 and transformation 212 may also be created. As shown in connection with timeline 204, transformations may be reverted to previous timestamps along timeline 204. The backward dashed arrows represent the fact that transformations may be reverted to any of the previous timestamps along the timeline, for example, transformation 4 could be reverted to ‘1’ or ‘2’ or ‘3.’

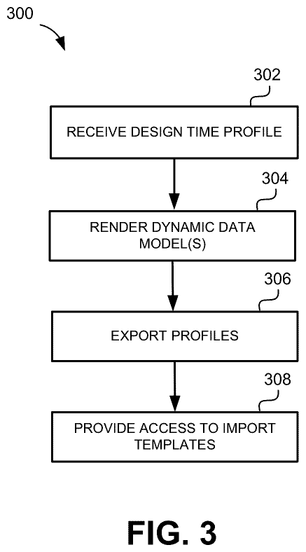

FIG. 3 shows an example method 300 of providing a transformation of data models in a dynamic extensible manner. First, at step 302, a design-time profile comprising a collection of transformations of a static data model into one or more dynamic data models is received. Next, at step 304, the one or more dynamic data models are rendered, during runtime of a software application, to create a data model variant. In some embodiments, multiple profiles for the one or more dynamic data models are created with varying levels of data model detail. In these embodiments, a plurality of transformations of the design-time profile are created at different time stamps. Next, at step 306, one or more exported profiles associated with the plurality of transformations of the design-time profile are exported by way of one or more machine readable templates. At step 308, the one or more machine readable templates are provided access to be imported into one or more target systems.

In some embodiments, the multiple profiles for the one or more dynamic data models are dynamically rendered with a plurality of run-time profiles creating variants of the one or more dynamic data models. In some other embodiments, the method further comprises creating a timeline as a series of created transformations thereby enabling recreation of the data model variant based on a time-slice associated with the timeline. In yet another embodiments, recreation of the data model variant based on the time-slice associated with the timeline is performed by moving up and down the timeline. In some embodiments, the method further comprises maintaining one or more higher-order profiles that encompass multiple static data models, wherein the one or more higher-order profiles comprise definitions of settings that are common across multiple static data models. In some embodiments, the method further comprises reusing the one or more one or more higher-order profiles to facilitate access to a composite dynamic data model containing information associated with the multiple static data models.

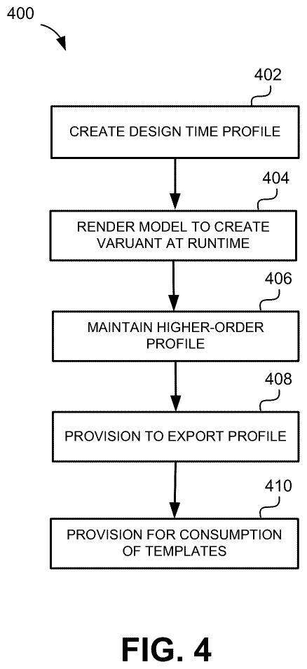

FIG. 4 is a flow diagram 400 illustrating another example method for providing a transformation of data models in a dynamic extensible manner according to certain embodiments. At step 402, systems consistent with the present teachings may create one or more design time profiles which may comprise one or more collections of transformations (attributes & behaviors) for a static data model. Next, at step 404, a profile renders the model to create a variant at runtime. Multiple profiles for the same model may be created with varying weights (levels of detail). The static data model may be dynamically rendered with many profiles creating different variants of the same model. Multiple transformations for the same profile can be created at different timestamps. A timeline may be created by a series of transformations. This enables creation and/or re-creation of the model variant based on a time-slice (by moving up or down a timeline).

At step 406, a higher-order profile can also be maintained which encompasses multiple models based on end-to-end purposes. Higher-order-profiles facilitate the definition of settings across data sets, such as for example, database tables, which may be common across data models. Use of higher-order profiles further improves the reusability of profiles. At step 408, provision may be made to export one or more profiles in a machine-readable template. Templates are reusable and may be published for consumption by various users and in connection with various systems. At step 410, provision may also be made for consumption of templates in target system via template imports.

Additional use cases may exist consistent with the present teachings. In a machine learning modeling scenario, data models may be generated iteratively to achieve greater accuracy. In some such embodiments, data models may be dynamically generated consistent with the present teachings. In these embodiments, training data sets may be employed including information regarding which aspects of certain data models are required in certain applications. In this way aspects regarding newly generated data models may be inferred in connection with a machine learning model to generate new data models for new applications when a new data model is required.

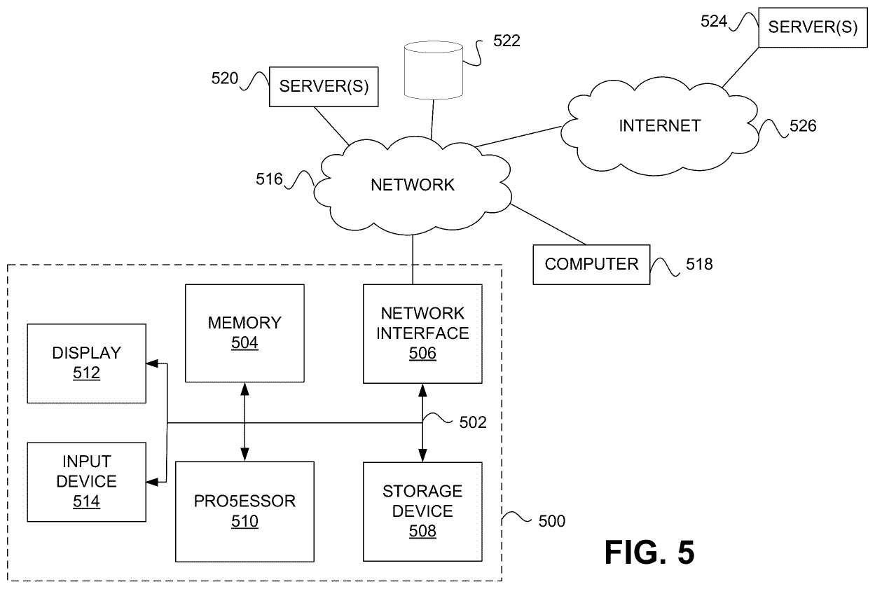

FIG. 5 is a diagram illustrating a sample computing device architecture for implementing various aspects described herein. Computer 500 can be a desktop computer, a laptop computer, a server computer, a mobile device such as a smartphone or tablet, or any other form factor of general- or special-purpose computing device containing at least one processor that may be employed to cause actions to be carried out. Depicted with computer 500 are several components, for illustrative purposes. Certain components may be arranged differently or be absent. Additional components may also be present. Included in computer 500 is system bus 502, via which other components of computer 500 can communicate with each other. In certain embodiments, there may be multiple busses or components may communicate with each other directly. Connected to system bus 502 is processor 510. Also attached to system bus 502 is memory 504. Also attached to system bus 502 is display 512. In some embodiments, a graphics card providing an input to display 512 may not be a physically separate card, but rather may be integrated into a motherboard or processor 510. The graphics card may have a separate graphics-processing unit (GPU), which can be used for graphics processing or for general purpose computing (GPGPU). The graphics card may contain GPU memory. In some embodiments no display is present, while in others it is integrated into computer 500. Similarly, peripherals such as input device 514 is connected to system bus 502. Like display 512, these peripherals may be integrated into computer 500 or absent. Also connected to system bus 502 is storage device 508, which may be any form of computer-readable media, such as non-transitory computer readable media, and may be internally installed in computer 500 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface 506 is also attached to system bus 502 and allows computer 500 to communicate over a network such as network 516. Network interface 506 can be any form of network interface known in the art, such as Ethernet, ATM, fiber, Bluetooth, or Wi-Fi (i.e., the Institute of Electrical and Electronics Engineers (IEEE) 802.11 family of standards). Network interface 506 connects computer 500 to network 516, which may also include one or more other computers, such as computer 518, server(s) 520, and network storage, such as cloud network storage 522. Network 516 is in turn connected to public Internet 526, which connects many networks globally. In some embodiments, computer 500 can itself be directly connected to public Internet 526 as well as one or more server(s) 524.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, for example as would a processor cache or other random-access memory associated with one or more physical processor cores.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims. Although the invention has been described with reference to the embodiments illustrated in the attached drawing figures, it is noted that equivalents may be employed, and substitutions made herein without departing from the scope of the invention as recited in the claims. The subject matter of the present disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the present claims. Terms should not be interpreted as implying any particular ordering of various steps described unless the order of individual steps is explicitly described.

The following detailed description of embodiments references the accompanying drawings that illustrate specific embodiments in which the present teachings can be practiced. The described embodiments are intended to illustrate aspects of the disclosed invention in sufficient detail to enable those skilled in the art to practice the invention. Other embodiments can be utilized, and changes can be made without departing from the claimed scope of the invention. The following detailed description is, therefore, not to be taken in a limiting sense. The scope of embodiments is defined only by the appended claims, along with the full scope of equivalents to which such claims are entitled.

Having thus described various embodiments of the invention, what is claimed as new and desired to be protected by Letters Patent includes the following:

1. One or more non-transitory computer-readable media storing computer-executable instructions that, when executed by a processor, perform a method for enabling transformation and extension of data models in connection with a dynamic, automated data processing mechanism, the method comprising:
receiving a design-time profile comprising a collection of transformations of a static data model into one or more dynamic data models;
rendering, during runtime of a software application, the one or more dynamic data models to create a data model variant,
wherein multiple profiles for the one or more dynamic data models are created with varying levels of data model detail, and
wherein a plurality of transformations of the design-time profile are created at different time stamps; and
exporting, by way of one or more machine readable templates, one or more exported profiles associated with the plurality of transformations of the design-time profile.

2. The non-transitory computer-readable media of claim 1, wherein the multiple profiles for the one or more dynamic data models are dynamically rendered with a plurality of run-time profiles creating variants of the one or more dynamic data models.

3. The non-transitory computer-readable media of claim 1, wherein the method further comprises:
creating a timeline as a series of created transformations thereby enabling recreation of the data model variant based on a time-slice associated with the timeline.

4. The non-transitory computer-readable media of claim 3, wherein recreation of the data model variant based on the time-slice associated with the timeline is performed by moving up and down the timeline.

5. The non-transitory computer-readable media of claim 1, wherein the method further comprises:
maintaining one or more higher-order profiles that encompass multiple static data models, wherein the one or more higher-order profiles comprise definitions of settings that are common across multiple static data models.

6. The non-transitory computer-readable media of claim 5, wherein the method further comprises:
reusing the one or more one or more higher-order profiles to facilitate access to a composite dynamic data model containing information associated with the multiple static data models.

7. The non-transitory computer-readable media of claim 1, wherein the method further comprises:
providing access to import the one or more machine readable templates into one or more target systems.

8. A method for enabling transformation and extension of data models in connection with a dynamic, automated data processing mechanism, the method comprising:
receiving a design-time profile comprising a collection of transformations of a static data model into one or more dynamic data models;
rendering, during runtime of a software application, the one or more dynamic data models to create a data model variant,
wherein multiple profiles for the one or more dynamic data models are created with varying levels of data model detail, and
wherein a plurality of transformations of the design-time profile are created at different time stamps; and
exporting, by way of one or more machine readable templates, one or more exported profiles associated with the plurality of transformations of the design-time profile.

9. The method of claim 8, wherein the multiple profiles for the one or more dynamic data models are dynamically rendered with a plurality of run-time profiles creating variants of the one or more dynamic data models.

10. The method of claim 9, wherein the method further comprises:
creating a timeline as a series of created transformations thereby enabling recreation of the data model variant based on a time-slice associated with the timeline.

11. The method of claim 10, wherein recreation of the data model variant based on the time-slice associated with the timeline is performed by moving up and down the timeline.

12. The method of claim 11, wherein the method further comprises:
maintaining one or more higher-order profiles that encompass multiple static data models, wherein the one or more higher-order profiles comprise definitions of settings that are common across multiple static data models.

13. The method of claim 12, wherein the method further comprises:
reusing the one or more higher-order profiles to facilitate access to a composite dynamic data model containing information associated with the multiple static data models.

14. The method of claim 8, wherein the method further comprises:
providing access to import the one or more machine readable templates into one or more target systems.

15. A system for enabling transformation and extension of data models in connection with a dynamic, automated data processing mechanism, the system comprising:
at least one processor;
and at least one non-transitory memory storing computer executable instructions that when executed by the at least one processor cause the system to carry out actions comprising:
receiving a design-time profile comprising a collection of transformations of a static data model into one or more dynamic data models;
rendering, during runtime of a software application, the one or more dynamic data models to create a data model variant,
wherein multiple profiles for the one or more dynamic data models are created with varying levels of data model detail, and
wherein a plurality of transformations of the design-time profile are created at different time stamps; and
exporting, by way of one or more machine readable templates, one or more exported profiles associated with the plurality of transformations of the design-time profile.

16. The system of claim 15, wherein the multiple profiles for the one or more dynamic data models are dynamically rendered with a plurality of run-time profiles creating variants of the one or more dynamic data models.

17. The system of claim 15, wherein the actions further comprise:
creating a timeline as a series of created transformations thereby enabling recreation of the data model variant based on a time-slice associated with the timeline.

18. The system of claim 17, wherein recreation of the data model variant based on the time-slice associated with the timeline is performed by moving up and down the timeline.

19. The system of claim 18, wherein the actions further comprise:
maintaining one or more higher-order profiles that encompass multiple static data models, wherein the one or more higher-order profiles comprise definitions of settings that are common across multiple static data models.

20. The system of claim 19, wherein the actions further comprise:
reusing the one or more higher-order profiles to facilitate access to a composite dynamic data model containing information associated with the multiple static data models.
